(19) United States
(12) Patent Application Publication
(10) Pub. No.: US 2002/0124940 A1
(43) Pub. Date: Sep. 12, 2002

(54) Method for manufacturing a label cover with joint lines positioned along folding traces

(76) Inventor: Fu-Chuan Huang, Chia-I Hsien (TW)

Correspondence Address: David E. Dougherty, Dennison, Schultz & Dougherty, 612 Crystal Square 4, 1745 Jefferson Davis Highway, Arlington, VA, 22202, US

(21) Appl. No.: 09/801,705

(22) Filed: Mar. 9, 2001

(51) Int. Cl. B29C 53/00

(52) U.S. Cl. 156/220; 156/213; 156/218

(57) ABSTRACT

A method for manufacturing a label cover with joint lines positioned along folding traces of a lateral side of the label is disclosed. A tubular heat contracting film is printed with various patterns and characters, and then the film is folded as a tubular label cover by a folding machine. One opening of the label cover is placed on a guide plate. The orientation between inlet end and the outlet end of the guide plate is adjustable. After the label cover passes through the guide plate, the position of the joint line is converted to the folding trace of the lateral side of the label cover. By the design of the inlet end and the outlet end of the guide plate, the respective angle after being folded is adjusted so that the overlapping portion of the joint line and the folding trace on the label cover is changed as desired. Therefore, the pattern and characters on the label cover are retained as original forms without being destroyed by the joint line. Then, an automatic label installation operation can be used to arrange the pattern on the label upon different bottle bodies so as not to destroy the outlook.

### BACKGROUND OF THE INVENTION

The present invention relates to a method for manufacturing a label cover with joint lines positioned along folding traces of a lateral side of the label, wherein a label cover passes through an inlet end and an outlet end of a guide plate in which the two ends are formed with an angle so that the overlapping portion of the joint line is at the lateral folding traces of the label cover so as to be suitable for packaging bottle bodies of convenient shapes.

The current commercial beverage bottle is enclosed by a label cover 1 as illustrated in FIG. 1. In that, a heat contracting film is printed with various advertised characters. Then the heat contracting film passes through a folding machine (a machine known in the prior art and thus the details will not be further described) to have a tubular shape. Then, glues A are coated on any end surfaces 11 at two sides of the heat contracting film (referring to FIG. 2). Then heat contracting film is pressed by rollers 12 at two sides and then passes through a size plate 13 for determining the size thereof. Thus, the label cover 1 has a tubular shape. Thereby, it is provides to a label installation machine for being covered with a label. However, the folded label cover 1 has a joint line 14 positioned on the surface of the label cover 1 and is shaped by the size plate 13. The label cover 1 is pulled by front transfer wheels so as to be formed with two folding traces 15 at two sides. When the label cover 1 covers on a bottle body B, the folding traces 15 (referring to FIG. 3) are at the edges of the bottle body B. Since in manufacturing a label cover 1, the joint line 14 must be left with a space for gluing (referring to FIG. 4) and thus it can not be positioned on the folding traces 15. Therefore, manual operations for adjusting the label cover are necessary. Furthermore, this effect can not be achieved in an automatic process so that as the label cover 1 covers on the bottle body B, the joint line 14 is possible at any surface of the bottle body. Therefore, the editions of the advertising pattern and characters are affected. Further, since two folding traces 15 are formed on the label cover 1, if the label cover is used to a polygonal bottle body B, the folding traces are difficult to be aligned with the edges.

### SUMMARY OF THE INVENTION

Accordingly, the object of the present invention is to provide a method for manufacturing a label cover with joint lines positioned along folding traces of a lateral side of the label, wherein a label cover passes through an inlet end and an outlet end of a guide plate which are formed with an angle so that the overlapping portion of the joint line is at the lateral folding traces of the label cover so as to be suitable to package bottle bodies of convenient shapes.

The various objects and advantages of the present invention will be more readily understood from the following detailed description when read in conjunction with the appended drawing.

### BRIEF DESCRIPTION OF THE DRAWINGS

FIG. 1 is a schematic view for folding a prior label cover.

FIG. 2 is a schematic view showing that the label cover is in a sticking condition.

FIG. 3 is a schematic view showing that a prior label cover is placed around a bottle body.

FIG. 4 is a schematic view showing the joint lines and folding traces of the prior label cover.

FIG. 5 is a schematic view showing the folding of a label cover.

FIG. 6 is a schematic view showing the guide plate of the present invention.

FIG. 7 is a schematic view showing that the present invention passes through a guide plate.

FIG. 8 is a schematic view showing a kind of overlapping way of the joint line and the new folding traces in the present invention.

FIG. 9 is a schematic view showing another kind of overlapping way of the joint line and the new folding traces in the present invention.

FIG. 10 is a schematic view showing that the label cover is placed upon a square bottle body.

FIG. 11 is a schematic view showing that the label cover is placed upon an elliptical bottle body.

FIG. 12 is a schematic view showing the folding process of a label cover in another embodiment of the present invention.

FIG. 13 is a schematic view showing that the inlet end and outlet end of the guide plate has an angle of 45 degrees

FIG. 14 is a schematic view showing that the label cover is placed upon a rectangular bottle body.

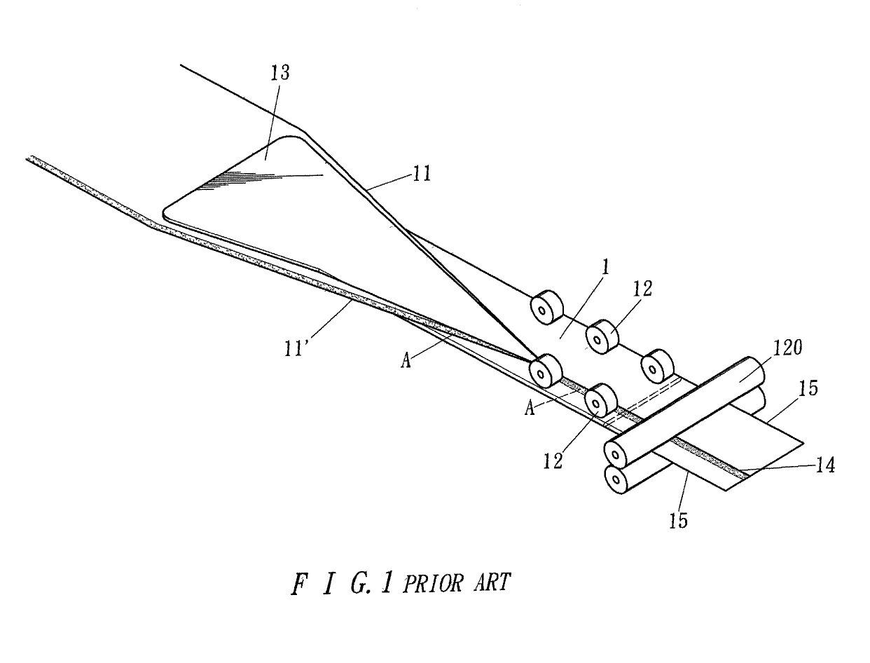

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

The present invention relates to a method for manufacturing a label cover with joint lines positioned along folding traces and the overlapping position on the label is adjustable. Furthermore, the cover can be positioned easily for being used to cover or package bottles of various shapes and forms.

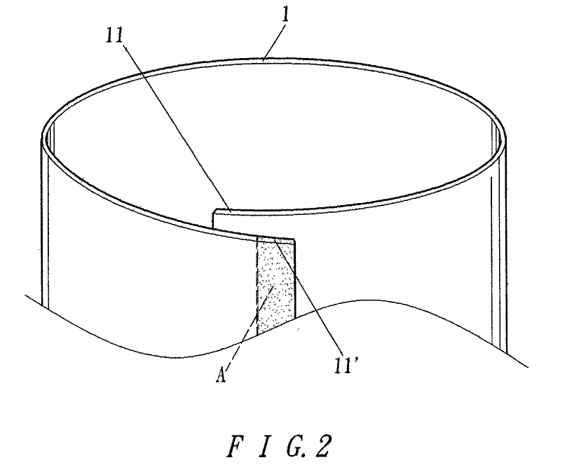

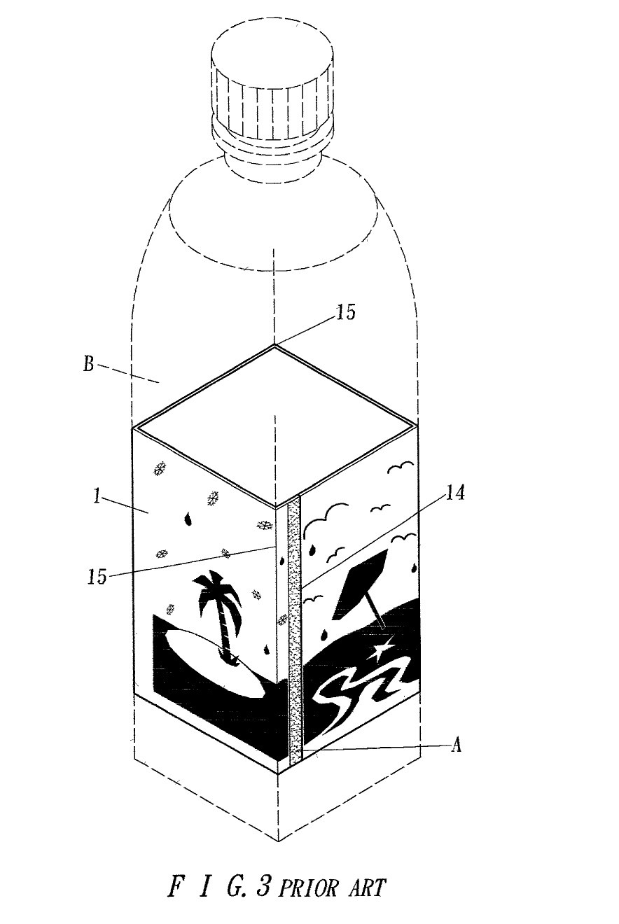

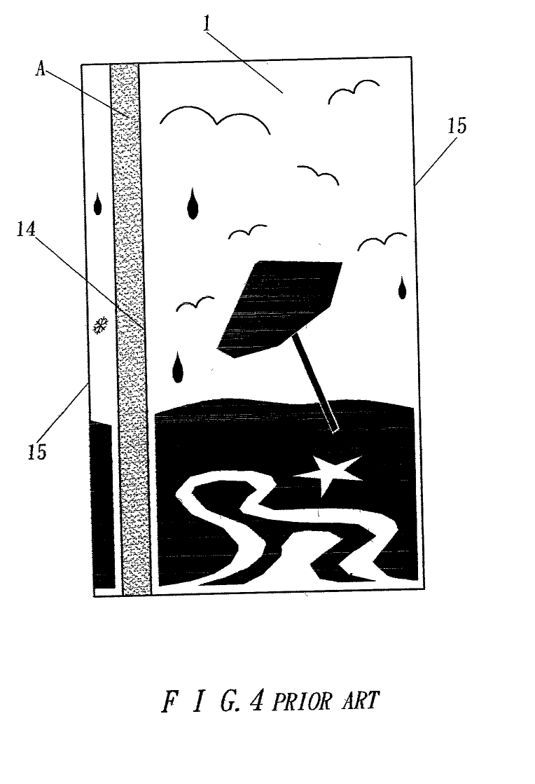

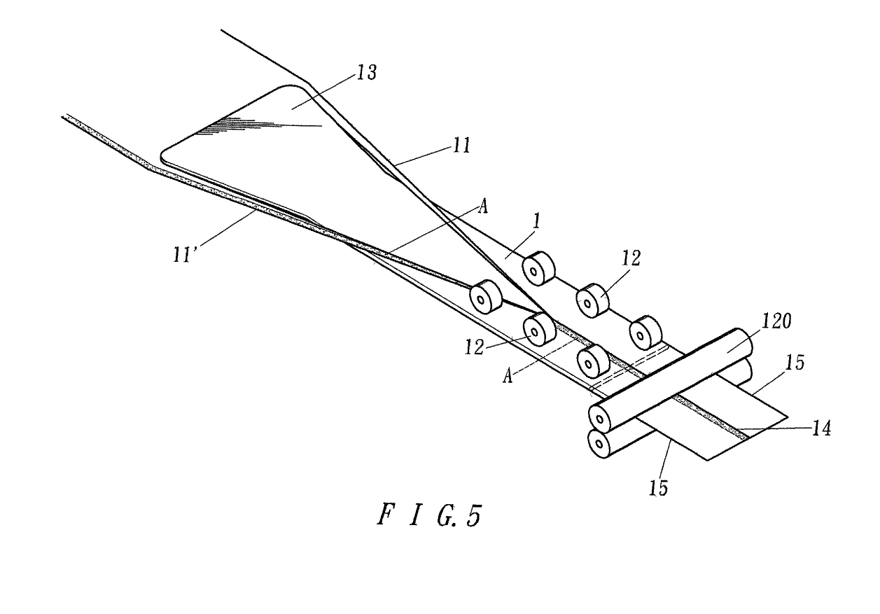

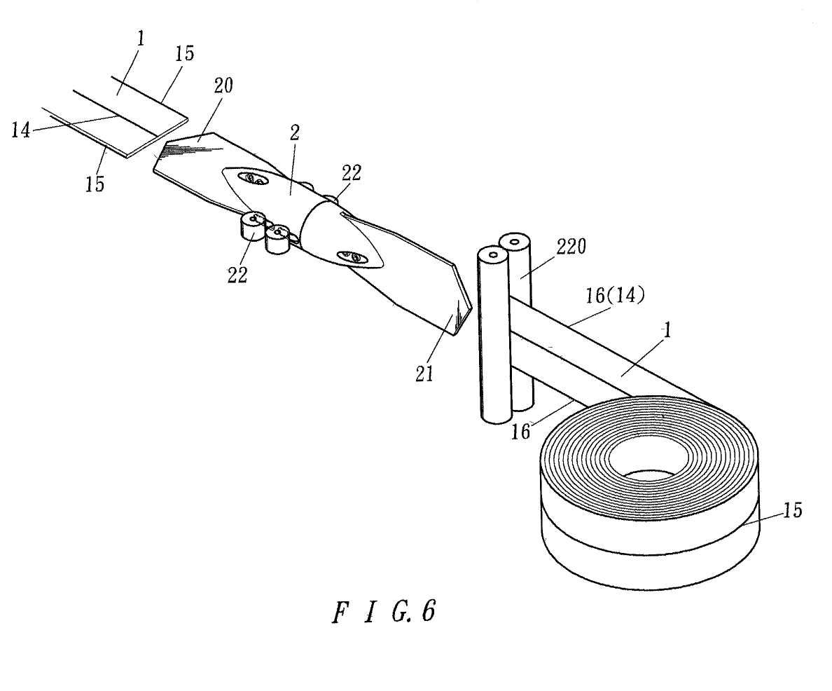

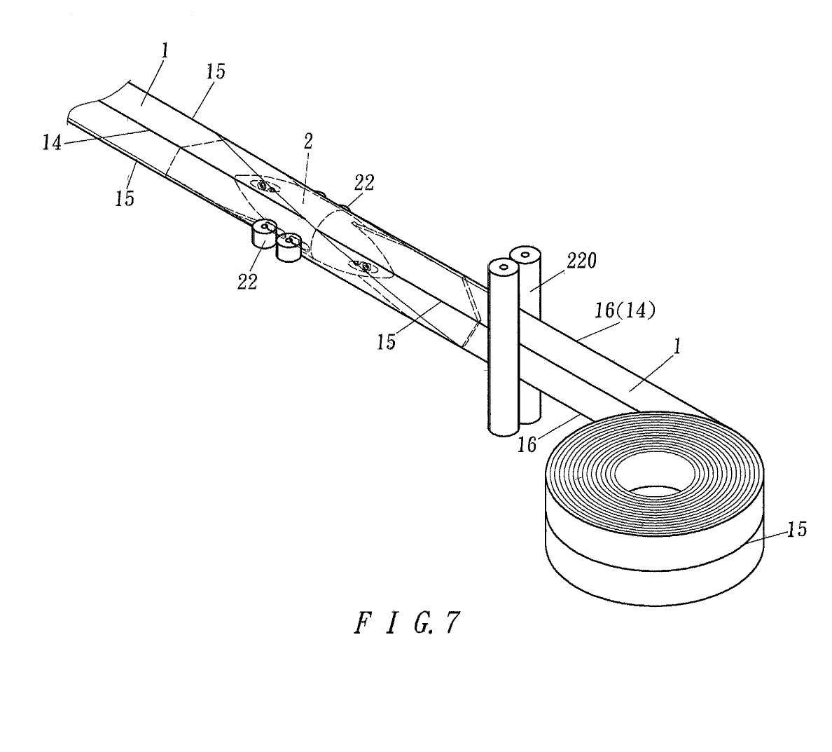

Referring to FIG. 5, various patterns or characters are printed on a heat contracting film. Then, the film is transferred to an aligning machine so that glues A are coated on any of end surfaces 11 and 11′ at two sides of the heat contracting film (referring to FIG. 2). When the heat contracting film passes through a size plate 13 for determining the size thereof The film is transferred through the rollers 12 at two sides and then press wheels 120 presses the film so that it has a flat shape and the film is transferred so that one end surface 11 of the heat contracting film is glued and combined with another end surface 11′ to be formed as a label cover 1. Parts of the label cover 1 at the two sides of the size plate 13 are formed with respective folding traces 15. Now, the heat contracting film is folded to be as a tubular label cover 1. After being folded, at the joint portion of the two end surfaces 11 and 11′ of the label cover 1 has a joint line 14. The joint line 14 is at a center of the front surface of the label cover 1 or shifted from the center with an angle. Then the opening of the label cover 1 covers upon a guide plate 2 of an orientation changing machine for being transferred (referring to FIG. 6). The inlet end 20 and outlet end 21 of the guide plate 2 are perpendicular to one another, while the angle between the inlet end 20 and the outlet end 21 can be adjusted within a range of 180 degrees as desired so that the overlapping portion of joint line 14 of the label cover 1 and the folding trace 15 are at a surface which can be changed by the orientation changing machine. When the label cover 1 enters into the inlet end 20 of the guide machine 2, it is transferred along the guide plate 2. Finally, it goes out from the outlet end 21 perpendicular to the inlet end (referring to FIG. 7). Then, it is rolled through the rollers 22 at two sides, and then it is pressed by two press wheels 220 after the rollers 22 so that the label cover 1 changes its direction and then is pressed into a flat shape. Then new folding traces 16 at two sides are formed, respectively. The overlapping portion of the joint line 14 is exactly positioned at the new folding traces 16. Finally, the label cover 1 is curled as a winding object. Therefore, the respective pattern is displaced so that the front side is aligned to the rear side. Therefore, as the label cover covers on a bottle, it is unnecessary to change the position of the pattern so that the operation of covering on a bottle can be positioned rapidly with less time.

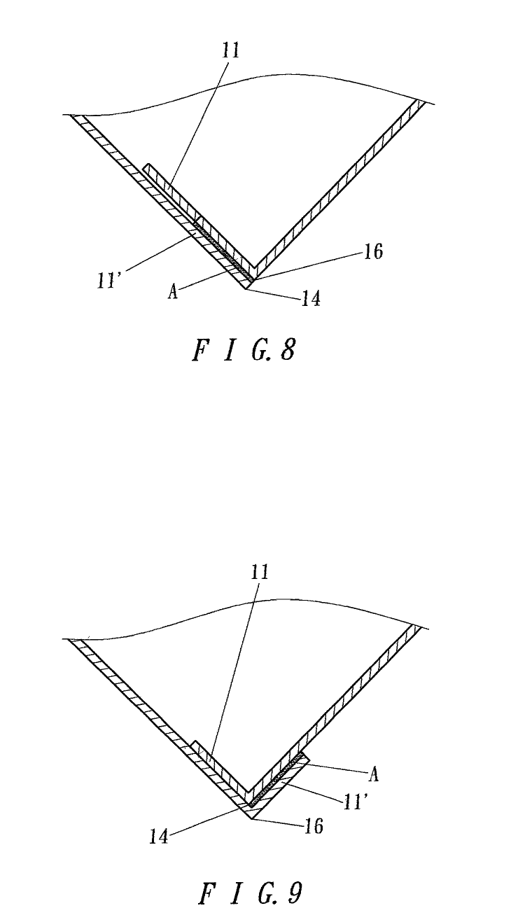

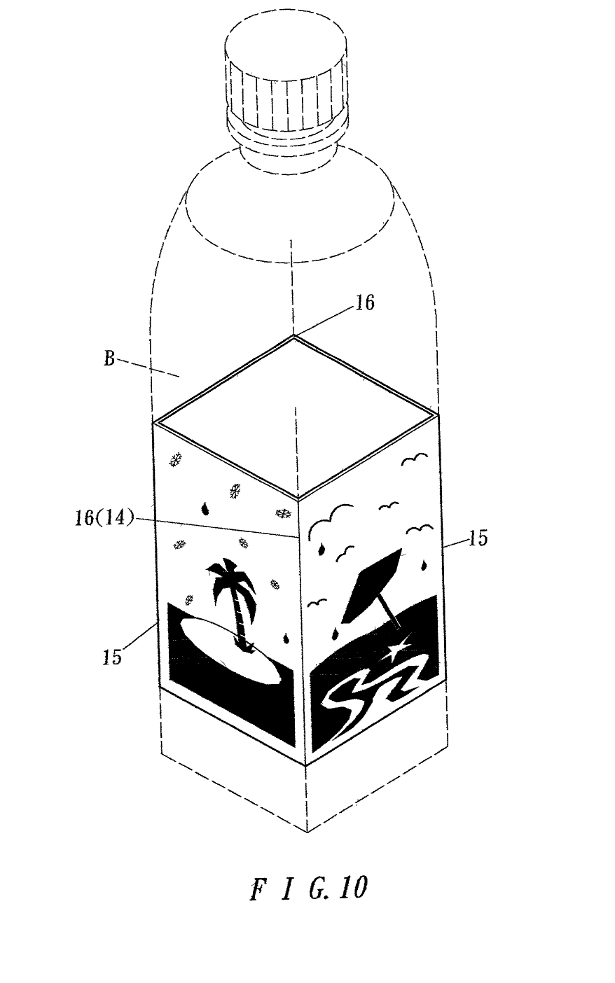

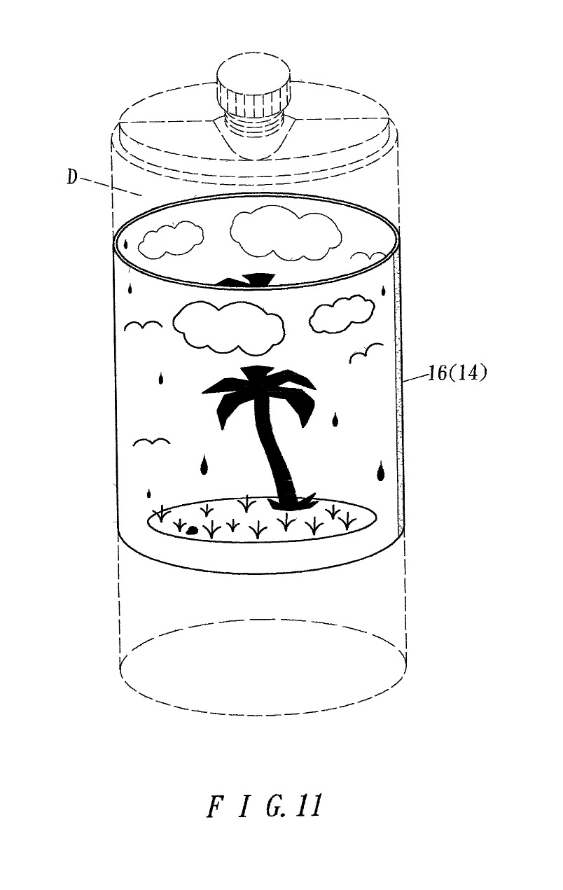

A glue A is coated on any one of the end surfaces 11 and 11′ of the label cover 1 so that the glue A is distributed through a width thereon. In the two end surfaces 11 and 11′, One of the two end surfaces 11′ of the label cover 1 is at an outer lateral side of the label cover 1, and another end surface 11 is at the inner lateral side of the label cover 1. Therefore, two selections are provided to the overlapping portion of the joint line 14 and the new folding traces 16. At a first selection, the end surface 11′ is as the basis of the joint line 14 to be tightly adjacent with the new folding trace 16 (referring to FIG. 8), while at another selection, the end surface 11 is used as a basis of the joint line 14 to be overlapped with the new folding trace 16 (referring to FIG. 9). The selection can be made as the requirement of packaging, and however, all these are within the scope of the present invention. The joint line 14 at the overlapping portion of the new folding trace 16 of the label cover 1 can be arranged on the square bottle body B (referring to FIG. 10) so that the joint line 14 and the new folding trace 16 are completely at the edges without affecting the outlook and completeness of the whole label. Furthermore, a label cover 1 has four folding traces 16 and 15 so that they can be used at four edges of a square bottle body B and the alignment work can be performed easily without any shifting.

When the label is used to an elliptical bottle body (referring to FIG. 11), after the heat contracting film is glued through the folding machine, the film is formed as a tubular label cover 1 so that the joint line 14 is positioned on the label cover 1 with an angle shift of 20 degrees. Then, a guide plate is adjusted so that the inlet end 20 and the outlet end 21 are adjusted to have an angle of 20 degrees. Thus, the joint line 14 is overlapped with the new folding trace 16 at the lateral side of the label cover 1. When it covers on the elliptical bottle body D, the joint line 14 can be adjusted at one lateral side of the bottle body. Then, the pattern is displaced by hands. In the process, an automatic label installation operation can be used so as not to destroy the outlook.

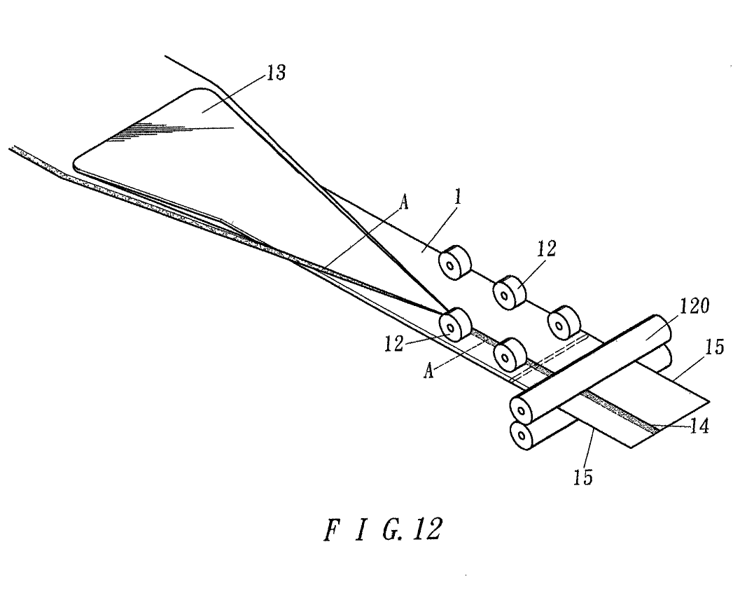

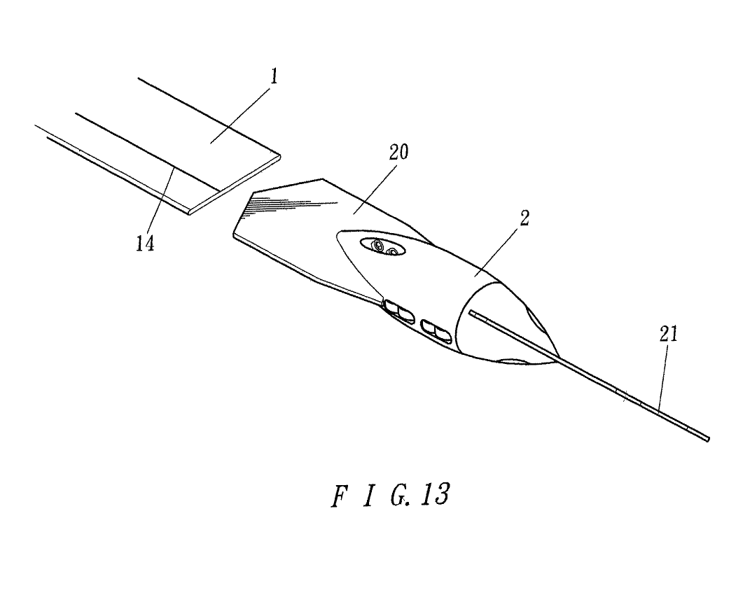

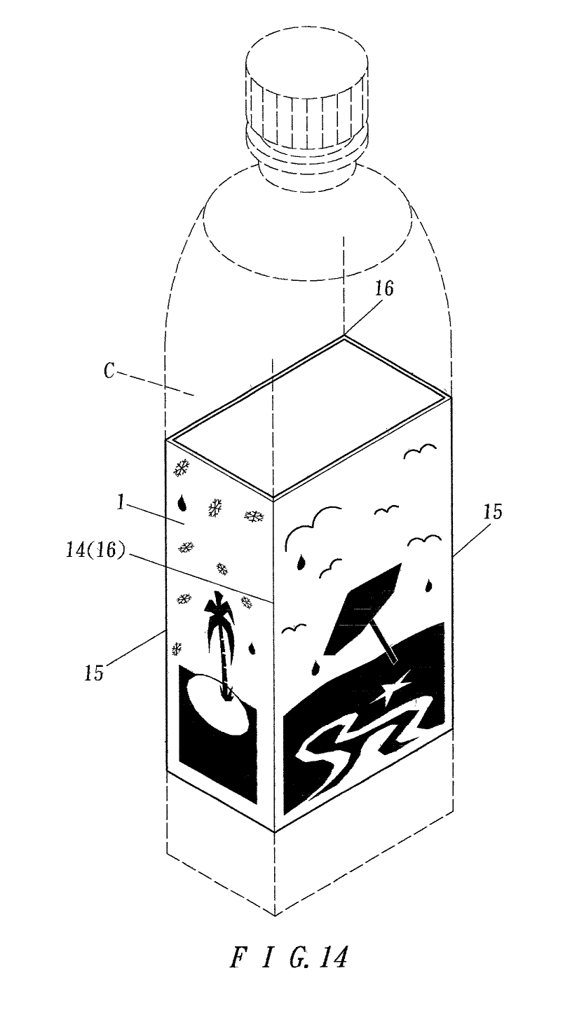

In another embodiment of the present invention, as illustrated in FIG. 12, as the present invention is used to bottle bodies of other shapes, such as a rectangular bottle body C, the heat contracting film can be adjusted by the size plate 13 and the roller 12 of the folding machine so that the joint line 14 is positioned at a proper position of the label cover 1. Then, the inlet end 20 and the outlet end 21 of the guide plate 2 are adjusted to have a different angle of 45 degrees (referring to FIG. 13). Then the overlapping portion of the joint line 14 and the new folding trace 16 are at the lateral side of the label cover 1 to has a proper distance from the old folding trace 15. The pattern and character are at a desired surface for holding and packaging the rectangular bottle body C (referring to FIG. 14).

From above description, it is appreciated that the present invention has the following advantage:

1. The joint line of a label cover is at the folding trace of a lateral side so as to match bottle bodies of different shapes and thereby, the pattern and character can be retained with a beautiful and complete outlook.

2. The manufacturing process is easy. It is only necessary to adjust the angle of the inlet end and outlet end of the guide plate of the orientation changing machine. Then, the joint line and the label cover are overlapped at different positions for being used to various bottle bodies of different shapes.

3. In the present invention, more than four folding traces (a plurality of folding traces are generated on the label cover so as to correspond to different edges of a bottle body. Therefore, the label is rapidly engaged with the bottle body without any shifting.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing a label cover with joint lines positioned along folding traces of a lateral side of a label, wherein a tubular heat contracting film is printed with various patterns and characters, then the film is folded as a tubular label cover by a folding machine, two sides of the label are folded to be formed with folding traces, and the joint portion is formed with a joint line; and
the label cover is engaged into an inlet end of the guide plate from an opening of the label cover, and then label cover is outputted from an outlet end of the guide plate; the inlet end and the outlet end of the guide plate has a predetermined angle; the label cover is transferred through the rollers at two sides and then press wheels press the label cover so as to has a flat shape and be formed with new folding traces for changing the positions of the pattern and characters; the joint line and the new folding trace are overlapped at lateral sides of the label cover; and finally, the label cover is curled as a winding object for covering on a bottle body.

2. The method for manufacturing a label cover with joint lines positioned along folding traces as claimed in claim 1, wherein the inlet end and outlet end of the guide plate is adjustable to has an angle difference within 180 degrees so that the joint line and the folding traces are at different positions of the label cover so as to package bottle bodies of different shapes.

3. The method for manufacturing a label cover with joint lines positioned along folding traces as claimed in claim 1, wherein the joint line of the label cover and the new folding traces are tightly overlapped and are at one lateral side of the label cover.

4. The method for manufacturing a label cover with joint lines positioned along folding traces as claimed in claim 3, wherein any end surface of the label cover is coated with glue to be combined with another end surface, therefore, the end surface is selected as a basis of the joint line to be tightly adjacent with the new folding trace, or another, the other end surface is selected as a basis of the joint line to be overlapped with the new folding trace.

5. The method for manufacturing a label cover with joint lines positioned along folding traces as claimed in claim 3, wherein the label cover has four folding traces and so that they are used at four edges of a square bottle body and the alignment work is performed easily without any shifting.
